(19) United States
(12) Patent Application Publication
(10) Pub. No.: US 2003/0196642 A1
(43) Pub. Date: Oct. 23, 2003

(54) Method and device for controlling fuel metering into an internal combustion engine

(76) Inventors: Derek Coates, Graben-Neudorf (DE); Patrick Amann, Ditzingen (DE); Lars Empacher, Stuttgart (DE)

Correspondence Address: KENYON & KENYON, ONE BROADWAY, NEW YORK, NY, 10004, US

(21) Appl. No.: 10/394,095

(22) Filed: Mar. 21, 2003

(30) Foreign Application Priority Data
Mar. 21, 2002 (GB) 102 12 509.0

(51) Int. Cl. F02M 51/00

(52) U.S. Cl. 123/446

(57) ABSTRACT

A device and a method for controlling fuel metering into an internal combustion engine are described. A fuel injection unit meters fuel to the engine as a function of at least a first trigger signal and a second trigger signal. The first trigger signal controls the start and the end of fuel metering, and the second trigger signal controls the fuel pressure buildup. The first trigger signal is predefined on the basis of signals which characterize the amount of fuel to be injected, the start of fuel metering, and the fuel pressure at the start of fuel metering.

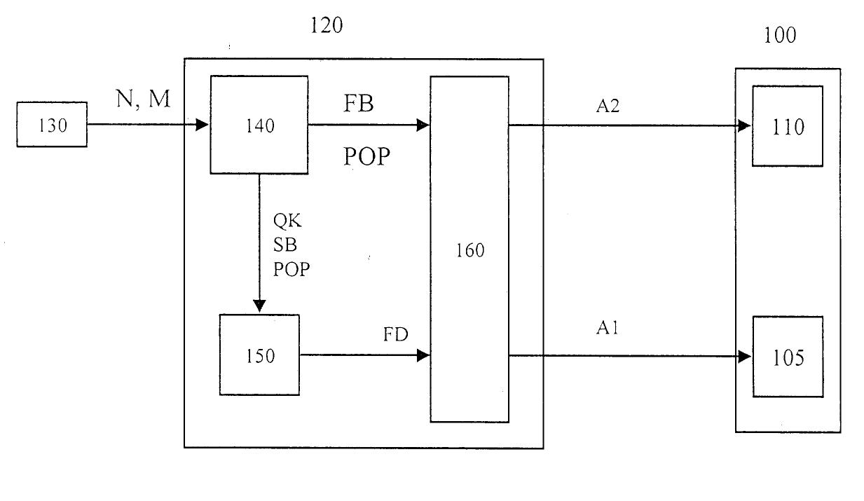

### FIELD OF THE INVENTION

The present invention relates to a method and a device for controlling fuel metering in an internal combustion engine.

### BACKGROUND INFORMATION

For metering fuel in internal combustion engines, fuel injection units are often used, which meter fuel into the engine as a function of trigger signals of a controller. Such fuel injection units may contain a first final controlling element, which controls the start and the end of fuel metering, and a second final controlling element, which controls the pressure that is available for fuel metering. Pump-nozzle units are preferably used for such fuel injection units. Such a fuel injection unit is known from European Patent No. 840 003, for example.

In conventional systems, the duration of fuel delivery, i.e., the interval between the start and end of fuel metering, is stored in a pump characteristics map as a function of different variables. The duration of fuel delivery is usually stored as a function of desired amount of fuel QK, current rotational speed N of the engine, and a start of delivery FB. This/these pump characteristics map or maps define the behavior of a given pump type when operated with a certain cam and are usually developed by the engine manufacturer. Pumps of a given type normally have a fixed nozzle opening pressure. Therefore, the dependence of the pump characteristics map on the above-mentioned parameters is sufficient.

If the pump characteristics maps of systems in which the nozzle opening pressure is influenceable were selected only as a function of the input variables: start of fuel delivery, rotational speed, and amount of fuel, this would result in the fact that different characteristics maps would have to be used for pilot injection, main injection, and post-injection, since the injected amount is considerably influenced by the nozzle needle opening pressure. The pressure variation depends on the entire prior history of an injection; therefore, new characteristics maps must be developed for each possible combination of delivery durations and pauses of all previous partial injections. This results in considerable adaptation cost in developing the characteristics maps.

### SUMMARY OF THE INVENTION

According to the present invention, in a method and a device for controlling fuel metering in an internal combustion engine in which a fuel injection unit meters fuel to the engine as a function of at least a first trigger signal and a second trigger signal, the trigger signal, in particular the duration of triggering, is predefined by a pump characteristics map as a function of signals which characterize the amount of fuel to be injected, the start of fuel metering, and the fuel pressure at the start of fuel metering.

It is advantageous that all partial injections are describable using the same pump characteristics maps. This considerably reduces the calibration costs, since only one characteristics map has to be developed for all partial injections. At the same time, the memory requirements in the controller are reduced.

### BRIEF DESCRIPTION OF THE DRAWING

The FIGURE shows a block diagram of the method according to the present invention.

### DETAILED DESCRIPTION

The duration of fuel delivery, i.e., the interval between the start and end of fuel metering, is usually stored in a pump characteristics map as a function of different variables. The duration of fuel delivery is usually stored as a function of desired amount of fuel QK, current rotational speed N of the engine, and a start of delivery FB. This/these pump characteristics map or maps define the behavior of a given pump type when operated with a certain cam and are usually developed by the engine manufacturer on a test bench. Such pump-nozzle systems usually have a nozzle opening pressure which is mechanically settable, but fixed for a given pump type. Therefore, the dependence of the pump characteristics map on the above-mentioned parameters is sufficient.

In more recent pump-nozzle units, a second final controlling element is provided which influences the nozzle opening pressure. This second actuator provides the option of selecting the nozzle needle opening pressure varying between the mechanical opening pressure and the maximum allowed injector pressure for each partial injection. If the pump characteristics maps were selected here only as a function of the input variables: start of delivery, rotational speed, and amount of fuel, this would result in the fact that different characteristics maps would have to be used for pilot injection, main injection, and post-injection, since the injected amount is considerably influenced by the nozzle needle opening pressure. The pressure variation depends on the entire prior history of an injection; therefore, new characteristics maps must be developed for each possible combination of delivery durations and pauses of all previous partial injections. This results in substantial adaptation costs in developing the characteristics maps.

Therefore according to the present invention, the pressure at the start of an injection is included as an additional input variable in the pump characteristics map to avoid calibration and development costs and to reduce the memory requirements needed in the controller. Thus it is achieved that all partial injections are describable by the same extended pressure-dependent pump characteristics map.

It is advantageous that all partial injections are describable using the same pressure-dependent pump characteristics maps. This considerably reduces the calibration costs, since only one characteristics map has to be developed for all partial injections. At the same time, the memory requirements in the controller are reduced.

The FIGURE shows the device according to the present invention using a block diagram. A fuel injection unit 100 includes a first final controlling element 105 and a second final controlling element 110. The start of injection and the end of injection—and therefore the injected amount—are influenceable using the first final controlling element. The start and the end of the pressure buildup are influenceable using the second final controlling element, this pressure buildup phase affecting the amount of fuel injected. The mechanical structure of such a fuel injection unit is described in European Patent 840 003, for example. The fuel injection unit described there is normally referred to as a pump-nozzle unit.

A controller 120 supplies the fuel injection unit with trigger signals A1 for the first final controlling element and trigger signals A2 for the second final controlling element. For this purpose, controller 120 analyzes signals of different sensors 130. The controller analyzes signal N of a rotational speed sensor and/or of a pedal sensor and/or a torque request M, among other things.

Controller 120 essentially includes a control unit 140, a pump characteristics map 150, and a trigger unit 160. Control unit 140 supplies pump characteristics map 150 with various signals, such as a signal QK which characterizes the desired amount of fuel to be injected, a signal FB, which characterizes the desired start of injection, and a signal POP, which characterizes the fuel pressure at the start of fuel injection. Pump characteristics map 150 converts these signals into a signal FD, which characterizes the duration of triggering and transmits [it] to the trigger unit. Furthermore, control unit 140 directly supplies trigger unit 160 with signals which characterize the start of injection and the pressure buildup. These signals are converted by trigger unit 160 into trigger signals A1 and A2 to be supplied to first and second final controlling elements, respectively.

A pump characteristics map 150, to which a signal regarding the injection start, i.e., start of fuel delivery, a rotational speed signal N, a signal QK which characterizes the amount of fuel to be injected, and a signal, which characterizes pressure POP prevailing in the high-pressure area of the fuel injection unit at the start of injection are supplied as input variables, is used according to the present invention. The pump characteristics map provides the computed duration of fuel delivery FD as an output variable. This pressure-dependent pump characteristics map is then used for all partial injections.

According to the present invention, pressure POP, which prevails at the start of injection, may be estimated from other variables internally in controller 120 or, in an alternative embodiment, may be detected by a suitable sensor. The trigger signal for the second final controlling element which controls the pressure buildup is used in particular for estimating the pressure.

What is claimed is:

1. A method of controlling a fuel metering into an internal combustion engine, comprising:
causing a fuel injection unit to meter a fuel to the internal combustion engine as a function of at least a first trigger signal and a second trigger signal, the first trigger signal controlling a start and an end of the fuel metering, and the second trigger signal controlling a fuel pressure buildup; and
predefining the first trigger signal on the basis of a first signal that characterizes an amount of the fuel to be injected, a second signal that characterizes the start of the fuel metering, and a third signal that characterizes a fuel pressure at the start of the fuel metering.

2. The method as recited in claim 1, further comprising:
predefining a duration of the first trigger signal on the basis of the first signal, the second signal, and the third signal.

3. The method as recited in claim 1, further comprising:
causing a first final controlling element to receive the first trigger signal; and
causing a second final controlling element to receive the second trigger signal.

4. A device for controlling a fuel metering into an internal combustion engine, comprising:
a fuel injection unit for metering a fuel to the internal combustion engine as a function of at least a first trigger signal and a second trigger signal, the first trigger signal controlling a start and an end of the fuel metering, and the second trigger signal controlling a fuel pressure buildup; and
an arrangement for predefining the first trigger signal on the basis of a first signal that characterizes an amount of the fuel to be injected, a second signal that characterizes the start of the fuel metering, and a third signal that characterizes a fuel pressure at the start of the fuel metering.
